(19) United States
(12) Patent Application Publication
(10) Pub. No.: US 2026/0268282 A1
(43) Pub. Date: Sep. 10, 2026

(54) SYSTEM

(71) Applicant: SOFTBANK GROUP CORP., Tokyo (JP)

(72) Inventor: Ken SONOBE, Tokyo (JP)

(73) Assignee: SOFTBANK GROUP CORP., Tokyo (JP)

(21) Appl. No.: 19/557,241

(22) Filed: Mar. 5, 2026

Related U.S. Application Data
(60) Provisional application No. 63/767,951, filed on Mar. 6, 2025.

(51) Int. Cl. G06Q 10/105; G06F 3/01; G10L 15/26

(52) U.S. Cl. CPC G06Q 10/105; G06F 3/013; G10L 15/26

(57) ABSTRACT

A VR simulation system for customer service industries, aiming to provide interactive responses based on the subject's speech and biometric information using generative AI is provided. This system includes a voice input unit, an eye-tracking unit, and a voice analysis unit, collecting and analyzing the subject's speech content, eye movements, and voice tone in real time. The generative AI generates appropriate responses based on this data, providing subjects with realistic complaint handling simulations. An evaluation unit scores the subject's responses against evaluation criteria, while a feedback unit provides detailed feedback based on the evaluation results. This enables subjects to efficiently acquire diverse complaint handling skills, contributing to improved customer satisfaction in customer service industries.

### CROSS-REFERENCE TO RELATED APPLICATION

This application claims priority under 35 U.S.C. § 119 to U.S. Provisional Patent Application No. 63/767,951, filed on Mar. 6, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for training for handling customer complaints in the service industry, conventional methods require creating separate simulation patterns for each business type, which demands considerable time and effort is disclosed. Furthermore, conventional simulations feature fixed responses to examinees' statements, making it difficult to cultivate the flexible response skills required in actual customer service settings. Additionally, evaluations do not consider examinees' biometric information, such as eye contact or voice tone, resulting in limited training effectiveness.

The disclosure aims to solve these issues by utilizing generative AI to generate real-time, interactive responses based on the subject's statements and biometric information, thereby providing more realistic simulations. This enables subjects to efficiently acquire diverse complaint handling skills, contributing to improved customer satisfaction in the service industry.

This invention proposes a means to solve the challenges in conventional complaint handling training by providing a VR simulation system for the service industry. This system includes an audio input unit that collects the subject's speech in real time, enabling immediate acquisition of the subject's spoken content. Furthermore, it includes an eye-tracking unit that tracks the subject's gaze, enabling detailed analysis of how the subject uses their gaze. Additionally, it incorporates a voice analysis unit that analyzes the subject's voice tone and volume, making it possible to grasp the emotional nuances of their speech.

Based on this data, a response generation unit utilizes generative AI to generate responses tailored to the subject's statements and biometric information. This enables the real-time generation of dynamic and appropriate responses to the subject's statements. Furthermore, an evaluation unit scores the subject's responses against established criteria and generates evaluation results, allowing for the objective assessment of the subject's interaction skills. Finally, a feedback provision unit is provided to offer feedback to the subject based on the evaluation results, enabling the subject to receive specific advice for improving their response skills. In this way, the entire system operates in coordination, enabling more effective and efficient training for handling customer complaints in the service industry.

### BRIEF DESCRIPTION OF THE DRAWING

FIG. 1 is a conceptual diagram showing an example configuration of the data processing system according to the first embodiment.

FIG. 2 is a conceptual diagram showing an example of the main functional components of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter referred to simply as a “processor”) may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface that includes a communication processor and an antenna, among other components. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, “A and/or B” is synonymous with “at least one of A and B.” That is, “A and/or B” may mean only A, only B, or a combination of A and B. Furthermore, in this specification, when three or more items are connected using “and/or,” the same concept applies as for “A and/or B”.

### First Embodiment

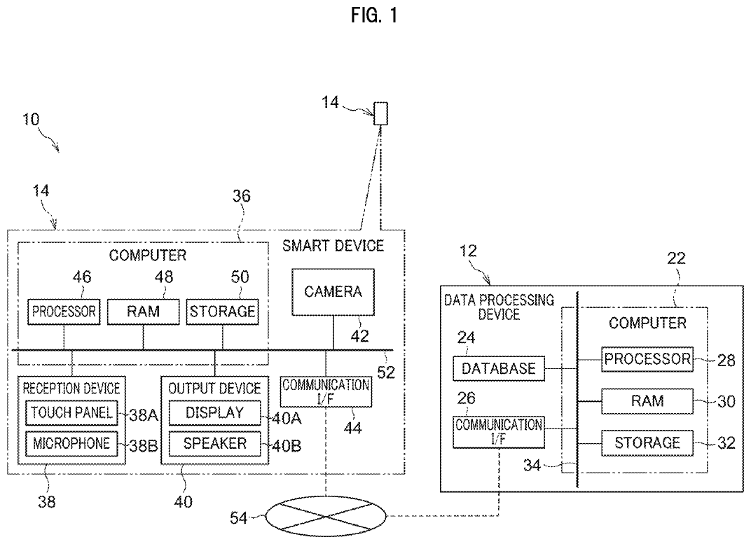

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, presenting data to user 20 by outputting it in a perceptible form (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

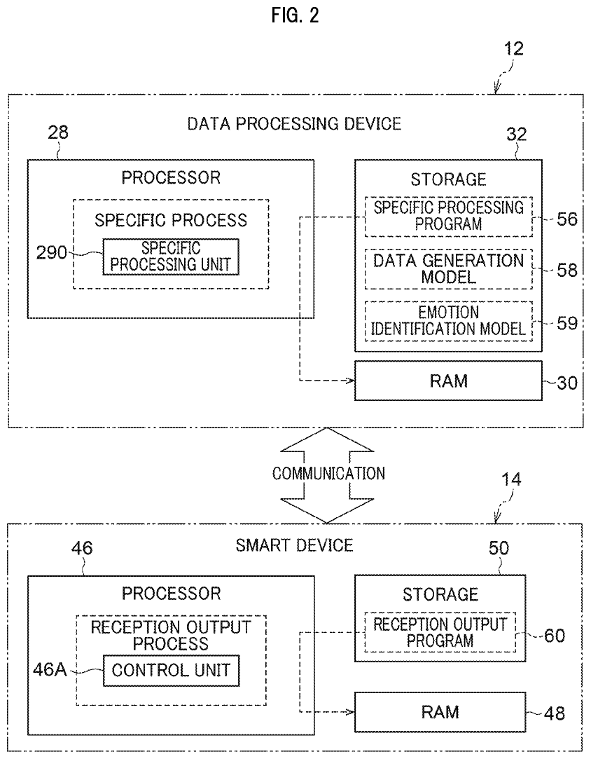

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the “server,” and the smart device 14 is referred to as the “terminal.”

### (Implementation Examples for Carrying Out the Invention)

An embodiment of the present invention implements a VR simulation system for the hospitality industry using a server and a terminal, enabling subjects to receive training in handling complaints within a VR environment. This system aims to provide real-time, interactive responses by utilizing generative AI.

First, the terminal side includes a VR headset worn by the subject. This headset provides the subject with a virtual customer service environment, enabling visually realistic simulation. For example, it can recreate a situation where the subject, in a restaurant customer service scenario, faces a character playing the role of a customer making a complaint. Furthermore, a microphone is connected to the terminal to accurately capture the subject's speech. This enables detailed analysis of how the subject responds to the complaint.

An eye-tracking device is also integrated into the terminal, tracking the subject's eye movements in real time. This device analyzes how the subject uses their gaze and is used to evaluate how eye movements influence interactions. For example, it can determine whether the subject can convey trustworthiness by looking into the eyes of the customer character while speaking.

Next, various modules for processing the collected data are placed on the server side. The speech input unit converts the subject's speech into text data and analyzes the content using natural language processing technology. For example, when a subject apologizes by saying “I'm sorry,” it accurately understands the intent and uses this as foundational data to generate an appropriate response.

The eye-tracking unit analyzes the subject's gaze data to identify how they are using their gaze. This enables evaluation of how gaze usage affects the effectiveness of the response. For example, if the subject avoids eye contact, causing the customer role-playing character to feel distrust, feedback is provided on how to improve this.

The voice analysis unit analyzes the subject's voice tone and volume to infer their emotional state. This allows the system to understand the emotional state with which the subject is interacting and evaluate the appropriateness of their response. For example, if the subject responds with an angry tone, the system provides feedback advising them to maintain composure.

The response generation unit, using generative AI, generates an appropriate response based on the subject's spoken content and biometric information. This AI generates responses to the subject's statements in real time, mimicking natural conversation. For example, if the subject asks, “How should I apologize?”, the AI generates a response such as, “We sincerely take your feedback to heart and will strive to improve our service going forward.”

The evaluation unit scores the subject's responses based on evaluation criteria. These criteria include appropriate language use, composure, promptness, and proper use of eye contact. For example, if the subject promptly offers an appropriate apology, that skill is highly evaluated.

The feedback provision unit provides feedback to the subject based on the evaluation results. This feedback is generated as a detailed report containing specific advice for the subject to improve their response skills. For example, specific suggestions such as “Increasing the frequency of directing your gaze toward the other person can help build greater trust” are provided.

In this way, the coordinated operation of the server and terminal enables more effective and efficient training for handling complaints in customer service industries. This system allows subjects to efficiently acquire diverse complaint-handling skills and is expected to contribute to improving customer satisfaction in customer service industries.

### (System Configuration)

The system according to this embodiment comprises a voice input unit, an eye-tracking unit, a voice analysis unit, a response generation unit, an evaluation unit, and a feedback provision unit. The voice input unit collects the subject's utterances in real time and converts them into text data. This unit acquires high-precision audio through a microphone to enable detailed analysis of how the subject responds to complaints. For example, if a subject apologizes by saying “I'm sorry,” this utterance is accurately transcribed into text for use in subsequent processing. Furthermore, by immediately analyzing the content of a subject's response when asked a question, it provides foundational data for evaluating the appropriateness of the response. Additionally, the voice input unit analyzes the subject's speaking speed and pausing patterns, generating data for evaluating the fluency of the response.

The eye-tracking unit tracks the subject's eye movements in real time and evaluates how their use of gaze affects the interaction. This unit uses an eye-tracking device to analyze in detail how the subject employs their gaze. For example, it determines whether the subject can convey trustworthiness by looking at the eyes of the customer role character while speaking. Furthermore, if the subject's averted gaze causes the customer role character to feel distrust, it provides feedback on points for improvement. Additionally, the eye-tracking unit analyzes how frequently the subject moves their gaze and evaluates how this gaze usage affects the effectiveness of the interaction.

The voice analysis unit analyzes the subject's voice tone and volume to infer their emotional state. This unit is used to understand the emotional state with which the subject is interacting and to evaluate the appropriateness of the interaction. For example, if the subject responds with an angry tone, it provides feedback advising them to remain calm. Conversely, if the subject responds with a calm tone, their composure is highly evaluated. Furthermore, the voice analysis unit analyzes the subject's vocal inflection and emphasis points to generate data for evaluating the persuasiveness of their responses.

The response generation unit uses generative AI to generate an appropriate response based on the subject's spoken content and biometric information. This AI generates responses to the subject's statements in real time, mimicking natural conversation. For example, if the subject asks, “How should I apologize?”, the AI generates a response such as, “We sincerely take your feedback to heart and will strive to improve our service going forward.” Furthermore, if the subject asks, “Is it possible to exchange the product?”, the AI generates a response such as, “Certainly. I will arrange it immediately.” Additionally, the response generation unit considers the subject's voice tone and eye movements to provide a more human-like interaction.

The evaluation unit scores the subject's responses based on evaluation criteria. This unit objectively assesses the subject's skills using criteria such as appropriate language, composure, promptness, and proper use of eye contact. For example, if the subject promptly offers an appropriate apology, their skill is highly rated. Additionally, if the subject maintains eye contact while speaking, their score for eye contact usage improves. Furthermore, the evaluation unit assesses the consistency and logical coherence of the subject's responses to determine their overall skill level.

The feedback provision unit provides feedback to the subject based on the evaluation results. This feedback is generated as a detailed report containing specific advice for the subject to improve their interaction skills. For example, specific suggestions such as “Increasing the frequency of directing your gaze toward the other person can convey greater trustworthiness” are provided. Additionally, advice such as “Lowering your voice tone can create a calmer impression” is also provided. Furthermore, the feedback provision unit proposes a specific training plan to enhance the subject's skills and supports preparation for the next simulation.

Specific examples of prompt sentences to be fed into the generative AI required for implementing the present invention include: “How should you respond when a customer is dissatisfied with a product?” “What is the optimal phrase to use to respond calmly when a customer is angry?” “How should you proceed with the procedure when a customer requests an exchange for a product?” These prompt sentences serve as foundational data for the AI to generate appropriate responses, providing subjects with a realistic simulation experience.

### Implementation Steps

Step 1: Data Collection

The subject puts on a VR headset and enters the simulation environment. Here, the subject's speech is collected in real-time via a microphone. An eye-tracking device is used to track the subject's gaze movements. Furthermore, voice analysis software is used to analyze the subject's voice tone and volume. This acquires biometric information such as the subject's spoken content, gaze movements, and vocal nuances.
Step 2: Response Generation

Using generative AI, appropriate responses are generated based on the subject's spoken content and biometric information. The AI employs natural language processing technology to generate responses to the subject's statements in real time. For example, if the subject asks, “How should I apologize?”, the AI generates a response such as, “We sincerely appreciate your feedback and will strive to improve our service going forward.” Examples of prompts fed to the generative AI include: “How should I respond when a customer is dissatisfied with a product?”, “What is the optimal phrase to remain calm when a customer is angry?”, and “How should I proceed with the exchange process when a customer requests a product exchange?”
Step 3: Response Evaluation

The subject's interaction is scored based on evaluation criteria. These criteria include appropriate language use, calmness, prompt response, and proper use of eye contact. For example, if the subject promptly offers an appropriate apology, their skill in this area is highly evaluated. Additionally, if the subject maintains eye contact while speaking, their score for eye contact usage improves. The evaluation unit assesses the consistency and logical coherence of the subject's response to determine their overall skill level.
Step 4: Providing Feedback

Feedback is provided to the subject based on the evaluation results. This feedback is generated as a detailed report containing specific advice for the subject to improve their response skills. For example, specific suggestions like “Increasing the frequency of directing your gaze toward the other person can convey greater trustworthiness” are provided. Additionally, advice such as “Lowering your voice tone can create a calmer impression” is provided. The feedback provision unit proposes specific training plans for the subject's skill improvement and supports preparation for the next simulation.

### Specific Use Cases

Consider a simulation system designed for training in handling customer complaints in the service industry. This system recreates a scenario where the subject wears a VR headset and faces a customer character in a virtual service environment. The subject speaks through a microphone, and their speech is collected in real-time by the voice input unit and converted into text data. The eye-tracking device tracks the subject's gaze movements and analyzes how they use their eyes. The voice analysis unit analyzes the subject's voice tone and volume to infer their emotional state.

The generative AI generates an appropriate response based on the subject's spoken content and biometric information. For example, if the subject states, “I am dissatisfied with the product quality,” the AI generates a response such as, “We sincerely appreciate your feedback and will strive to improve the product.” Examples of prompt sentences fed to the generative AI include: “How should one respond when a customer is dissatisfied with product quality?”, “How should procedures be handled when a customer requests a return?”, and “What is the optimal phrase for calmly responding when a customer is angry?”

The evaluation unit scores the subject's response based on evaluation criteria. These criteria include appropriate language use, calmness, promptness, and proper use of eye contact. For example, if the subject promptly offers an appropriate apology, that skill is highly evaluated. Additionally, if the subject maintains eye contact while speaking, their score for eye contact usage improves.

The feedback provision unit provides feedback to the subject based on the evaluation results. This feedback is generated as a detailed report containing specific advice for the subject to improve their interaction skills. For example, specific suggestions such as “Increasing the frequency of directing your gaze toward the other person can help convey greater trustworthiness” are provided. Furthermore, advice such as “Lowering your voice tone can help convey a calmer impression” is also provided. The feedback section proposes specific training plans to improve the subject's skills and supports preparation for the next simulation.

In this way, the coordinated operation of the entire system enables more effective and efficient training for handling complaints in customer service roles. This system is expected to enable subjects to efficiently acquire diverse complaint handling skills, thereby contributing to improved customer satisfaction in the service industry.

### Application Example 1

The flow of specific processing in Application Example 1 is described below. The system components described below are implemented by the data processing device 12 and the smart device 14. The data processing device 12 is referred to as the “server,” and the smart device 14 is referred to as the “terminal.”

### Implementation Examples for the Present Invention

An embodiment of the present invention is a VR simulation system for training staff in nursing care facilities, utilizing generative AI to provide real-time interactive responses. This system enables nursing staff to experience various care scenarios and acquire appropriate response skills.

First, the system has care staff wear VR headsets, recreating situations where they encounter characters representing elderly individuals within a virtual care facility environment. This environment mimics an actual care facility, with detailed recreations of elderly residents' living spaces and common areas. Examples include scenarios such as an elderly person watching TV in the living room, eating in the dining room, bathing assistance scenes, and nighttime rounds.

The voice input unit collects the caregiving staff's spoken words in real time and converts them into text data. This enables detailed analysis of how staff address the elderly. For instance, a scenario might involve a staff member saying, “Good morning. How are you today?” This utterance is immediately transcribed by the voice input unit and used for subsequent analysis.

The eye-tracking unit tracks the movement of the staff member's gaze and analyzes how they use their eyes. This allows for an evaluation of how the use of gaze affects interactions. For example, it can determine whether the staff member makes eye contact with the elderly person while speaking, thereby conveying a sense of trust. Furthermore, if the staff member avoids eye contact, potentially causing the elderly person to feel distrust, the system provides feedback on how to improve this aspect. Furthermore, the eye-tracking unit analyzes how frequently the staff member moves their gaze and evaluates how this gaze usage affects the effectiveness of the interaction.

The voice analysis unit analyzes the staff member's voice tone and volume to infer their emotional state. This allows the system to understand the emotional state with which the staff member is interacting and evaluate the appropriateness of the interaction. For example, if a staff member responds with an angry tone, the system provides feedback advising them to maintain calmness. Conversely, if a staff member responds with a calm tone, their composure is highly evaluated. The voice analysis unit analyzes voice inflection and emphasis points to generate data for evaluating the persuasiveness of the response.

The AI-based Response Generation Unit uses collected data to generate real-time responses tailored to various situations within caregiving scenarios. This AI generates real-time replies to the subject's statements, mimicking natural conversation. For example, if an elderly person with dementia is confused, the AI generates calming phrases like, “It's okay. This is a safe place. Is there anything I can help you with?” For an elderly person who has fallen, it generates responses to ensure safety, such as, “Are you hurt? Let's get up slowly. Don't push yourself.” Furthermore, the AI selects words of comfort or encouragement based on the elderly person's emotions, enabling more human-like interactions.

The evaluation unit scores the caregiver's response based on evaluation criteria. These criteria include appropriate language, calmness, promptness, and proper use of eye contact. For example, if a staff member promptly offers an appropriate apology, their skill in this area is highly evaluated. Similarly, if a staff member maintains eye contact with the elderly person while speaking, their score for eye contact usage improves. The evaluation unit assesses the consistency and logical coherence of the staff member's response to determine their overall skill level.

The Feedback Provision Department provides feedback to care staff based on the evaluation results. This feedback is generated as a detailed report containing specific advice for staff to improve their interaction skills. For example, specific suggestions like “Increasing the frequency of directing your gaze toward the elderly can provide a greater sense of reassurance” are provided. Advice such as “Using a calmer tone of voice can create a more composed impression” is also provided. The Feedback Provision Department proposes specific training plans for staff skill improvement and supports preparation for the next simulation.

In this way, the coordinated operation of the entire system enables more effective and efficient staff training within care facilities. This system is expected to enable care staff to efficiently acquire the skills needed to handle diverse care scenarios, thereby contributing to improved service quality within care facilities.

### System Configuration

The system according to this embodiment comprises a voice input unit, an eye-tracking unit, a voice analysis unit, a response generation unit, an evaluation unit, and a feedback provision unit. The voice input unit collects the care staff's utterances in real time and converts them into text data. This unit acquires high-precision audio through a microphone to analyze in detail how staff address the elderly. For example, a scenario is envisioned where a staff member says, “Good morning. How are you today?” This utterance is immediately transcribed by the voice input unit and used for subsequent analysis. Furthermore, by instantly analyzing the staff member's response when asked a question, it provides foundational data for evaluating the appropriateness of the interaction. Additionally, the voice input unit analyzes the staff member's speaking speed and pausing patterns, generating data to evaluate the fluency of the interaction.

The eye-tracking unit tracks the staff member's eye movements in real time and evaluates how their use of eye contact affects the interaction. This unit uses an eye-tracking device to analyze in detail how the staff member uses their gaze. For example, it determines whether the staff member can convey trustworthiness by looking the elderly person in the eye while speaking. Furthermore, if the staff member's averted gaze causes the elderly person to feel distrust, the unit provides feedback on how to improve this. Furthermore, the eye-tracking unit analyzes how frequently staff move their gaze and evaluates how their gaze usage affects the effectiveness of interactions.

The voice analysis unit analyzes the staff member's voice tone and volume to infer their emotional state. This unit is used to understand the emotional state with which the staff member is interacting and to evaluate the appropriateness of the interaction. For example, if the staff member responds with an angry tone, it provides feedback advising them to maintain calmness. Conversely, if the staff member responds with a calm tone, their composure is highly evaluated. Furthermore, the voice analysis unit analyzes the intonation and emphasis points in the staff member's voice to generate data for evaluating the persuasiveness of the interaction.

The Response Generation Unit uses generative AI to generate responses in real time for various situations within care scenarios based on collected data. This AI generates responses to staff statements in real time, mimicking natural conversation. For example, if an elderly person with dementia is confused, the AI generates appropriate calming phrases like, “It's okay. This is a safe place. Is there anything I can help you with?” to calm them. For an elderly person who has fallen, it generates responses ensuring safety, such as “Are you hurt? Let's get up slowly. Don't push yourself.” Furthermore, the AI selects words of comfort or encouragement based on the elderly person's emotions, enabling more human-like interactions. Specific examples of prompts to feed into the AI include: “How should one respond when an elderly person with dementia is confused?” “How should one safely respond when an elderly person has fallen?” “How should one reassure an elderly person expressing anxiety?”

The evaluation unit scores the care staff's responses based on evaluation criteria. This unit objectively assesses staff skills using criteria such as appropriate language, composure, promptness, and proper use of eye contact. For example, if a staff member promptly offers an appropriate apology, their skill in this area is highly evaluated. Similarly, if a staff member maintains eye contact with the elderly person while speaking, their score for eye contact usage improves. Furthermore, the Evaluation Department assesses the consistency and logical coherence of staff interactions to determine their overall skill level.

The Feedback Provision Department provides feedback to care staff based on evaluation results. This feedback is generated as a detailed report containing specific advice for staff to improve their interaction skills. For example, specific suggestions like “Increasing the frequency of directing your gaze toward the elderly can provide a greater sense of reassurance” are provided. Advice such as “Using a calmer tone of voice can create a more composed impression” is also provided. The Feedback Provision Department proposes specific training plans for staff skill improvement and supports preparation for the next simulation.

In this way, the coordinated operation of the entire system enables more effective and efficient staff training within care facilities. This system is expected to enable care staff to efficiently acquire the skills needed to handle diverse care scenarios, thereby contributing to improved service quality within care facilities.

### Implementation Steps

Step 1: Data Collection

Care staff wear VR headsets and enter a virtual care facility environment. This environment simulates an actual care facility, with detailed recreations of elderly residents' living spaces and common areas. Staff speech is collected in real-time via microphones, and the voice input component converts this into text data. Eye-tracking devices are used to track staff gaze movements and analyze how they use their gaze. Voice analysis software analyzes the tone and volume of the staff's voice to infer their emotional state. This data serves as foundational information for subsequent response generation and evaluation.
Step 2: Response Generation

The generative AI generates responses in real time for various situations within the caregiving scenario based on the collected data. The AI considers the staff member's spoken content, eye movements, and voice tone to mimic natural conversation. For example, if an elderly person with dementia is confused, the AI generates appropriate calming words such as generate appropriate calming words such as, “It's okay. This is a safe place. Is there anything I can help you with?” For an elderly person who has fallen, it generates responses to ensure safety, such as “Are you in pain? Let's get up slowly. Don't push yourself.” Specific examples of prompts fed to the generative AI include: “How should one respond when an elderly person with dementia is confused?” “How should one safely respond when an elderly person falls?”, and “How should one reassure an elderly person expressing anxiety?”
Step 3: Response Evaluation

Score the care staff's response based on evaluation criteria. Evaluation criteria include appropriate language use, calmness, prompt response, and proper use of eye contact. For example, if a staff member promptly offers an appropriate apology, their skill in this area is highly evaluated. Additionally, if a staff member maintains eye contact with the elderly person while speaking, their score for eye contact usage improves. The evaluation unit assesses the consistency and logical coherence of the staff member's response to determine their overall skill level.
Step 4: Providing Feedback

Feedback is provided to care staff based on the evaluation results. This feedback is generated as a detailed report containing specific advice for staff to improve their interaction skills. For example, specific suggestions like “Increasing the frequency of directing your gaze toward the elderly can provide a greater sense of reassurance” are made. Additionally, advice such as “Calming your voice tone can create a calmer impression.” The feedback provision section proposes specific training plans for staff skill improvement and supports preparation for the next simulation.

### Specific Use Case

For example, consider a simulation system designed for training new staff at a nursing facility. This system uses VR technology to recreate a virtual nursing facility environment, enabling new staff to experience various caregiving scenarios. These scenarios include diverse situations elderly individuals might encounter during daily life. Examples include recreating scenes where a dementia patient becomes confused and wanders the facility, a scene where there is a risk of aspiration during meals, or a scene where an elderly person expresses anxiety at night.

In this system, the voice input unit collects staff speech in real time and converts it into text data. The eye-tracking unit tracks the staff member's gaze movements and analyzes how they are using their gaze. The voice analysis unit analyzes the staff member's voice tone and volume to infer their emotional state. This data is analyzed by a generative AI and used as foundational data to generate appropriate responses in real time.

The generative AI generates responses tailored to various situations within caregiving scenarios based on the collected data. For example, if an elderly person with dementia is confused, the AI generates appropriate calming words such as, “It's okay. This is a safe place. Is there anything I can help you with?” Additionally, if there is a risk of aspiration during meals, the AI generates responses to ensure safety, such as “Please chew slowly and swallow carefully. Don't push yourself.” Specific examples of prompt sentences fed to the generative AI include: “How should one respond when an elderly person with dementia is confused?”, “How should one safely respond when an elderly person is at risk of aspiration?”, and “How should one reassure an elderly person expressing anxiety at night?”

The evaluation unit scores the care staff's responses based on evaluation criteria. These criteria include appropriate language use, calmness, prompt response, and proper use of eye contact. For example, if a staff member responds promptly and appropriately, their skill is highly evaluated. Additionally, if a staff member can speak while maintaining eye contact with the elderly person, their score for eye contact usage improves.

The Feedback Provision Unit provides feedback to care staff based on the evaluation results. This feedback is generated as a detailed report containing specific advice for staff to improve their interaction skills. For example, specific suggestions such as “Increasing the frequency of directing your gaze toward the elderly can provide a greater sense of reassurance” are made. Advice such as “Using a calmer tone of voice can create a more composed impression” is also provided.

In this way, the coordinated operation of the entire system enables more effective and efficient staff training within care facilities. This system is expected to enable care staff to efficiently acquire the skills needed to handle diverse care scenarios, thereby contributing to improved service quality within care facilities.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

Data Generation Model 58 is a so-called generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

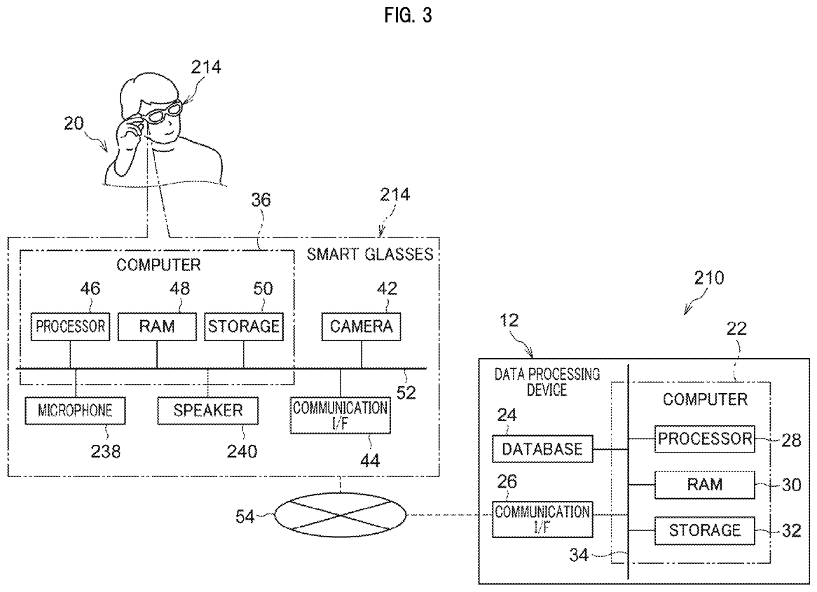

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge-Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

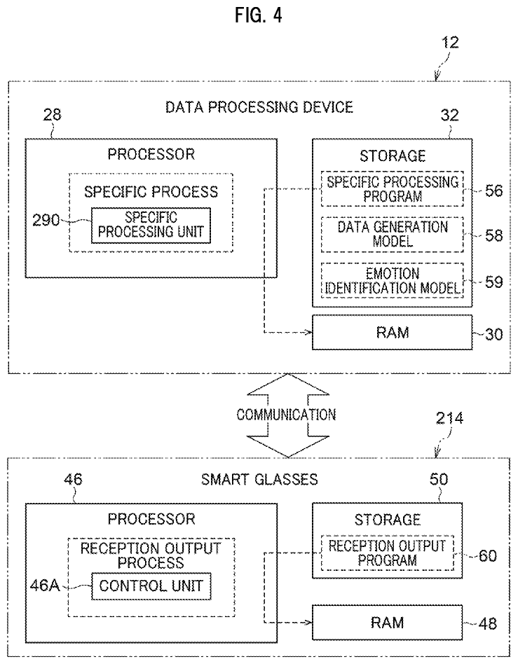

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a “program” related to the technology of this disclosure. Processor 28 reads the specific processing program 56 from storage 32 and executes the read specific processing program 56 on RAM 30. The specific processing is realized by processor 28 operating as a specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the “server,” and the smart glasses 214 are referred to as the “terminal.”

### Example 1

The flow of the specific processing is the same as that described in Example 1 of the first embodiment, so the explanation is omitted.

### Application Example 1

The flow of the specific processing in Example 1 described in the above first embodiment is the same, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input prompts containing instructions, as well as inference data such as audio data representing sound, text data representing text, and image data (e.g., still image data or video data) representing images. Data generation model 58 infers based on the input inference data according to the instructions indicated by the prompt and outputs the inference result in one or more of the data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

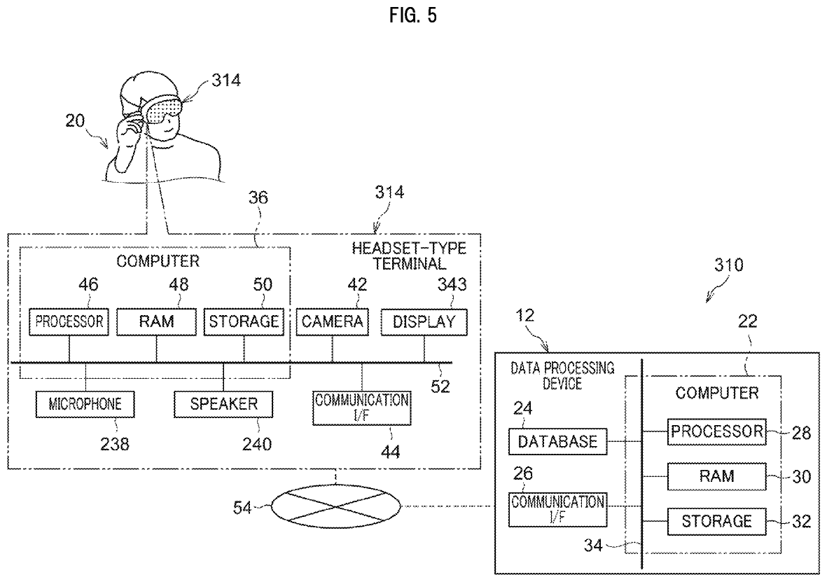

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a “computer” according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

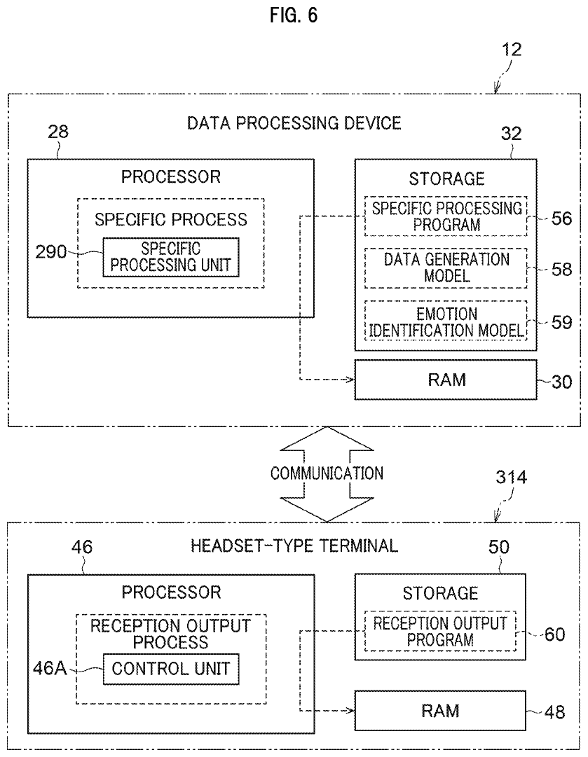

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. The processor 46 reads the reception output program 60 from the storage 50 and executes the read reception output program 60 on the RAM 48. Reception output processing is realized by the processor 46 operating as a control unit 46A according to the reception output program 60 executed on the RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the “server,” and the headset-type terminal 314 is referred to as the “terminal.”

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats such as audio data, text data, and image data. The data generation model 58 includes, for example, text generation AI, image generation AI, multimodal generation AI, etc. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the headset-type terminal 314.

### Fourth Embodiment

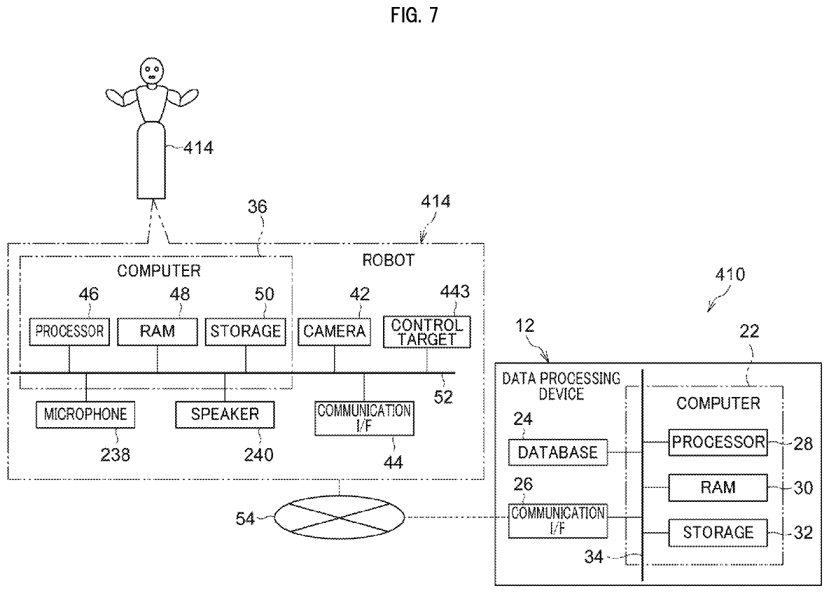

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a “computer” related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

The microphone 238 receives voice output from the user 20, thereby accepting instructions and the like from the user 20. The microphone 238 captures the voice output from the user 20 and converts the captured audio into audio data, which it outputs to the processor 46. The speaker 240 outputs audio in accordance with instructions from the processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414′s emotions can be expressed by controlling these motors. Furthermore, the robot 414's facial expressions can also be expressed by controlling the light emission state of the LEDs in its eyes.

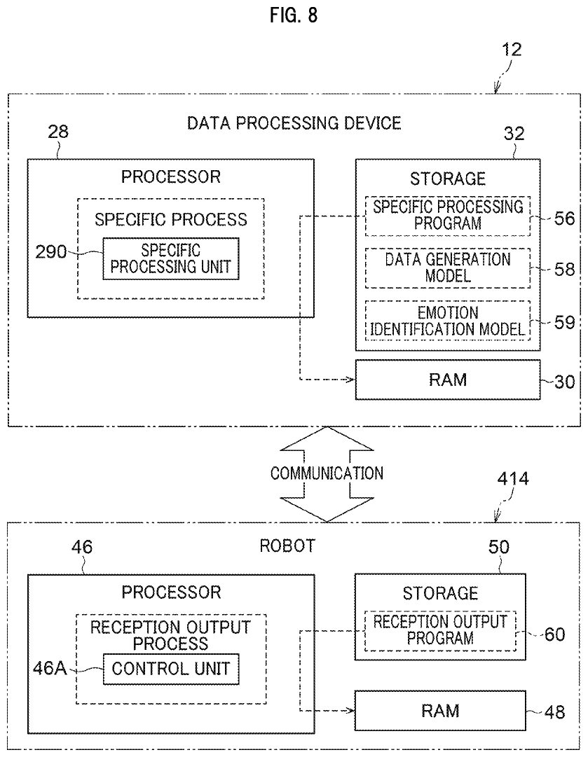

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a “program” related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the “server,” and the robot 414 is referred to as the “terminal.”

### Example 1

The flow of the specific processing is the same as that described in Example 1 of the first embodiment, so the explanation is omitted.

### Application Example 1

The flow of the specific processing in Example 1 described in the first embodiment is the same as above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL:https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and this data is processed by the specific processing unit 290 of the data processing device 12. For example, the analysis unit may be realized by the specific processing unit 290 of the data processing device 12, and it analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

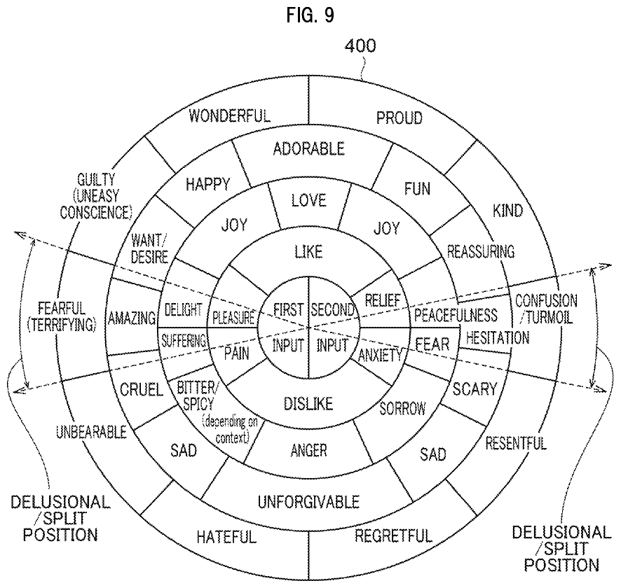

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. On the left side of the concentric circles are generally emotions generated from reactions occurring within the brain. On the right side are generally emotions induced by situational judgment. Above and below the concentric circles are generally emotions generated from reactions occurring within the brain and also induced by situational judgment. Furthermore, the upper part of the concentric circle contains “pleasant” emotions, while the lower part contains “unpleasant” emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents actions. Therefore, the further out on the emotion map 400, the more visible the emotion becomes (manifesting in actions).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. The emotion map is, for example, Dr. Mitsuyoshi's Emotion Map (Based on research on speech emotion recognition and neurophysiological signal analysis of emotions, Tokushima University, Doctoral Dissertation: https://ci.nii.ac.jp/naid/500000375379). The left half of the emotion map displays emotions belonging to the “Reaction” domain, where sensory aspects predominate. The right half of the emotion map displays emotions belonging to the “Situation” domain, where situational awareness is dominant.

Two emotions that promote learning are defined in the emotion map. One is the negative emotion around the center of the “repentance” or “reflection” area on the situation side. That is, when the robot experiences negative emotions like “I never want to feel this way again” or “I don't want to be scolded anymore.” The other is the positive emotion around “Desire” on the reaction side. That is, when the robot feels positive emotions like “I want more” or “I want to know more.”

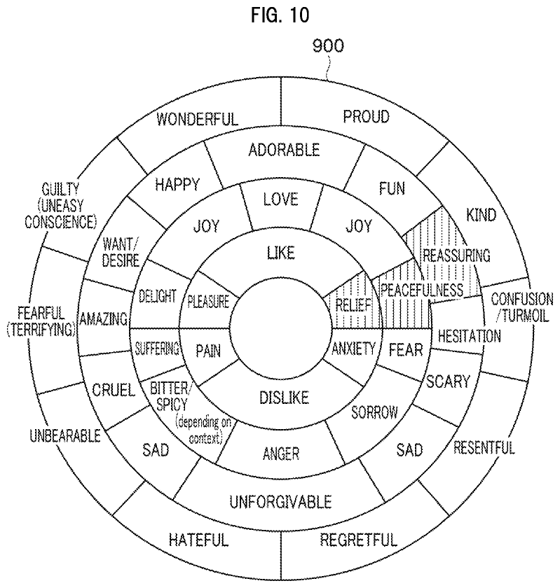

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as “reassurance,” “tranquility,” and “confidence,” have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone, etc. The method of the present disclosure may be provided to users in a SaaS (Software as a Service) format.

The above embodiment illustrated an example where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data.

The above embodiment described a configuration where a specific processing program 56 is stored in storage 32, but the technology disclosed herein is not limited to this. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., programs. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing the specific processing. Second, there is a form using a processor that implements the entire system's functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects pertaining to the technology disclosed herein. Therefore, it goes without saying that within the scope that does not deviate from the spirit of the technology disclosed herein, unnecessary portions may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure have been omitted from the above descriptions and illustrations.

All references, patent applications, and technical specifications cited herein are incorporated by reference to the same extent as if each reference, patent application, and technical specification were specifically and individually cited herein.

The following further details are disclosed regarding the above embodiments.

### Supplementary Note 1

A training system for staff in nursing care facilities, comprising a voice input unit, an eye-tracking unit, a voice analysis unit, a response generation unit using generative AI, an evaluation unit, and a feedback provision unit. The voice input unit collects nursing staff speech in real time and converts it into text data. The eye-tracking unit tracks staff eye movements and evaluates how their gaze usage affects interactions. The voice analysis unit analyzes the tone and volume of the staff member's voice to infer their emotional state. The response generation unit, utilizing generative AI, generates appropriate responses in real time for various situations within care scenarios based on the collected data. The evaluation unit scores the staff member's responses against established criteria, and the feedback provision unit provides detailed feedback based on the evaluation results.

The system described in Supplementary Note 1, wherein care staff wear VR headsets to recreate a situation facing a character representing an elderly person in a virtual care facility environment, and the generative AI generates responses in real time. The AI generates appropriate words to calm a confused elderly person with dementia and generates responses to ensure safety for an elderly person who has fallen.

A system as claimed in Supplementary Note 1 that scores the care staff's responses based on evaluation criteria and provides feedback as a detailed report. The system described in Supplementary Note 1. The evaluation criteria include appropriate language, calmness, prompt response, and proper use of eye contact. The feedback includes specific advice such as increasing the frequency of directing eye contact toward the elderly person and using a calmer tone of voice.

### EXPLANATION OF SYMBOLS

10, 210, 310, 410 Data Processing System
12 Data Processing Device
14 Smart Device
214 Smart Glasses
314 Headset-type devices
414 Robot

What is claimed is

1. A virtual-reality training system, comprising:
a terminal device including:
a head-mounted display configured to render a simulated service environment,
a microphone configured to capture speech of a subject,
an eye-tracking sensor configured to detect gaze direction and gaze duration of the subject,
a camera configured to capture image data of the subject,
a first processor, and
a first memory storing a reception-output program; and
a server device communicatively coupled to the terminal device via a network, the server device including:
a second processor,
a RAM used as working memory,
a non-volatile storage storing:
a specific processing program,
a data generation model comprising a trained neural network configured to generate natural-language responses, and
an emotion identification model comprising a trained neural network configured to output emotion values corresponding to coordinates within a predefined emotion map,
wherein execution of the specific processing program by the second processor causes the server device to:
receive multimodal input data from the terminal device including speech data, gaze data, and image data;
convert the speech data into text data and extract acoustic parameters including tone, volume, speech rate, and vocal inflection;
determine, using the emotion identification model, multidimensional emotion values mapped to coordinates within the predefined emotion map, the predefined emotion map comprising:
concentric regions in which inner regions represent primitive emotional states and outer regions represent behavior-manifested emotional states,
an upper region representing pleasant emotions and a lower region representing unpleasant emotions,
a reaction domain region and a situation domain region positioned on opposite sides of the map;
generate, using the data generation model, a simulated character response conditioned on both the text data and the multidimensional emotion values;
compute an evaluation score based on predefined evaluation criteria including:
appropriateness of language,
logical coherence,
composure derived from acoustic parameters, and
eye-contact frequency derived from the gaze data; and
transmit response data and structured feedback data to the terminal device for output within the simulated service environment.

2. The system of claim 1, wherein the emotion identification model is trained using paired training datasets including multimodal input data and corresponding emotion-map coordinate values.

3. The system of claim 1, wherein adjacent emotions within the emotion map are constrained during training to produce correlated output vectors.

4. The system of claim 1, wherein the evaluation score includes a numerical gaze-contact metric calculated from a ratio of gaze duration directed toward a virtual character relative to total speaking duration.

5. The system of claim 1, wherein the structured feedback data includes automatically generated behavioral recommendations derived from deficiencies in individual evaluation criteria.

6. The system of claim 1, wherein at least one of the emotion identification model or the data generation model is executed using a GPU or FPGA.

7. A computer-implemented method for controlling an interactive simulation executed by one or more processors, the method comprising:
collecting multimodal biometric input from a wearable device including speech data, gaze tracking data, and image data;
extracting linguistic features from the speech data and acoustic features including pitch, volume, and speech tempo;
inputting at least the linguistic features and acoustic features into a trained neural network configured to output emotion values corresponding to coordinates within a concentric emotion map;
identifying whether the coordinates correspond to:
a reflection region associated with negative learning-promoting emotions, or
a desire region associated with positive learning-promoting emotions;
generating, using a generative artificial intelligence model, a context-adaptive character response conditioned on both the linguistic features and the identified region of the emotion map;
computing a multi-factor evaluation score including language appropriateness, vocal calmness, promptness, and gaze usage; and
generating feedback including specific behavioral adjustment instructions derived from the multi-factor evaluation score.

8. The method of claim 7, wherein the wearable device comprises a VR headset configured to simulate a complaint-handling scenario.

9. The method of claim 7, wherein identifying the reflection region triggers generation of corrective feedback emphasizing improvement of composure.

10. The method of claim 7, wherein identifying the desire region triggers reinforcement feedback to promote learning motivation.

11. The method of claim 7, further comprising updating at least one weighting parameter of the evaluation score based on accumulated historical performance data.

12. The method of claim 7, wherein the generative artificial intelligence model is a multimodal generation model capable of receiving text and acoustic feature input.

13. A human-interaction system, comprising:
a robot including:
a microphone,
a camera,
a speaker,
a plurality of motors configured to control posture and gesture,
light-emitting elements configured to simulate facial expressions, and
a first processor; and
a server device including a second processor and memory storing:
a data generation model, and
an emotion identification model configured to output coordinates within a predefined emotion map;
wherein the server device is configured to:
receive user speech data and image data from the robot;
determine user emotion values mapped to coordinates within the predefined emotion map;
generate response data using the data generation model conditioned on the emotion values; and
transmit control signals to the robot that cause:
adjustment of at least one motor to modify posture or gesture corresponding to the mapped emotion values, and
modification of a light emission state of the light-emitting elements to represent an emotional expression corresponding to the mapped emotion values.

14. The system of claim 13, wherein the predefined emotion map distinguishes between reaction-domain emotions and situation-domain emotions.

15. The system of claim 13, wherein motor adjustments include alteration of arm elevation or head inclination corresponding to pleasant or unpleasant emotion regions.

16. The system of claim 13, wherein light-emitting elements are configured to vary intensity or color based on vertical position within the emotion map.

17. The system of claim 13, wherein the emotion identification model is trained such that temporally adjacent emotional states produce smooth coordinate transitions.

18. The system of claim 13, wherein at least part of the processing is distributed between the robot processor and the server processor.
